(19) United States
(12) Patent Application Publication
(10) Pub. No.: US 2026/0341286 A1
(43) Pub. Date: Oct. 29, 2026

(54) AUDIO SIGNAL PROCESSING METHOD AND APPARATUS, AND DEVICE AND STORAGE MEDIUM

(71) Applicant: ALIBABA INNOVATION PRIVATE LIMITED, Singapore (SG)

(72) Inventor: Shengkui ZHAO, Singapore (SG)

(21) Appl. No.: 19/106,970

(22) PCT Filed: Dec. 14, 2023
(86) PCT No.: PCT/CN2023/138837

§ 371 Date: Feb. 26, 2025

(30) Foreign Application Priority Data
Dec. 28, 2022 (CN) 202211702084.4

(51) Int. Cl. G10L 19/02; G10L 19/06; G10L 25/18

(52) U.S. Cl. CPC G10L 19/0204; G10L 19/06; G10L 25/18

(57) ABSTRACT

An audio signal processing method and apparatus, and a device and a storage medium. By encoding a first complex spectrogram corresponding to an original audio signal to obtain a first feature map, and respectively processing a time sequence and a frequency sequence corresponding to the first feature map to obtain a second feature map, and learning complex ratio masking and complex spectral mapping at the same time according to the second feature map, both the amplitude spectrum and phase of the original audio signal are enhanced by means of combining masking prediction and spectral prediction, thereby improving the speech enhancement effect.

### CROSS-REFERENCE TO RELATED APPLICATIONS

The present application is a National Stage of International Application No. PCT/CN2023/138837, filed on Dec. 14, 2023, which claims priority to Chinese Patent Application No. 202211702084.4, filed to China National Intellectual Property Administration on Dec. 28, 2022 and entitled “AUDIO SIGNAL PROCESSING METHOD AND APPARATUS, AND DEVICE AND STORAGE MEDIUM”. The two applications are hereby incorporated by reference in their entireties.

### TECHNICAL FIELD

The present disclosure relates to the field of information technologies and, in particular, to an audio signal processing method and apparatus, and a device and a storage medium.

### BACKGROUND

At present, speech enhancement technologies include denoising, loudness enhancement, echo cancellation and reverberation removal, etc.

However, after using the current speech enhancement technologies to enhance an audio signal, good noise reduction results cannot be obtained.

### SUMMARY

In order to solve the above technical problem or at least partially solve the above technical problem, the present disclosure provides an audio signal processing method and apparatus, and a device and a storage medium to solve the noise interference problem and improve the speech recognition effect.

In a first aspect, an embodiment of the present disclosure provides an audio signal processing method, including:
acquiring an original audio signal;
encoding a first complex spectrogram corresponding to the original audio signal to obtain a first feature map;
respectively processing a time sequence and a frequency sequence corresponding to the first feature map to obtain a second feature map;
predicting complex ratio masking and complex spectral mapping according to the second feature map; and
generating a second complex spectrogram according to the complex ratio masking and the complex spectral mapping, and generating a speech-enhanced target audio signal according to the second complex spectrogram.

In a second aspect, an embodiment of the present disclosure provides an audio signal processing apparatus, including:
an acquisition module, configured to acquire an original audio signal;
an encoding module, configured to encode a first complex spectrogram corresponding to the original audio signal to obtain a first feature map;
a processing module, configured to respectively process a time sequence and a frequency sequence corresponding to the first feature map to obtain a second feature map;
a prediction module, configured to predict complex ratio masking and complex spectral mapping according to the second feature map; and
a generating module, configured to generate a second complex spectrogram according to the complex ratio masking and the complex spectral mapping, and generate a speech-enhanced target audio signal according to the second complex spectrogram.

In a third aspect, an embodiment of the present disclosure provides an electronic device, including:
a memory;
a processor; and
a computer program;
where the computer program is stored in the memory and configured to be executed by the processor to implement the method as described in the first aspect.

In a fourth aspect, an embodiment of the present disclosure provides a computer-readable storage medium on which a computer program is stored, where the computer program is executed by a processor to implement the method described in the first aspect.

### BRIEF DESCRIPTION OF DRAWINGS

The accompanying drawings, which are incorporated in and constitute a part of the specification, illustrate embodiments consistent with the present disclosure, and serve to explain the principles of the present disclosure together with the description.

In order to explain the technical scheme in the embodiments of the present disclosure or related technologies more clearly, the drawings needed in the description of the embodiments or related technologies will be briefly introduced below. Obviously, for an ordinary person skilled in the art, other drawings can be obtained according to these drawings without paying creative labor.

FIG. 1 is a flowchart of an audio signal processing method provided by an embodiment of the present disclosure.

FIG. 2 is a schematic diagram of an application scenario provided by an embodiment of the present disclosure.

FIG. 3 is an architecture diagram of a D2Former provided by an embodiment of the present disclosure.

FIG. 4 is a schematic structural diagram of a complex dual-path encoder provided by an embodiment of the present disclosure.

FIG. 5 is a schematic structural diagram of a complex dual-path conformer block provided by another embodiment of the present disclosure.

FIG. 6 is a schematic structural diagram of a complex dual-path masking decoder provided by another embodiment of the present disclosure.

FIG. 7 is a schematic structural diagram of a complex dual-path spectral decoder provided by another embodiment of the present disclosure.

FIG. 8 is a schematic structural diagram of an audio signal processing apparatus provided by another embodiment of the present disclosure.

FIG. 9 is a structural schematic diagram of an embodiment of an electronic device provided by an embodiment of the present disclosure.

### DESCRIPTION OF EMBODIMENTS

In order to understand the above purposes, features and advantages of the present disclosure more clearly, the scheme of the present disclosure will be further described below. It should be noted that the embodiments of the present disclosure and the features in the embodiments can be combined with each other without conflict.

In the following description, many specific details are set forth in order to fully understand the present disclosure, but the present disclosure may be practiced in other ways than those described herein; obviously, the embodiments in the specification are only part of the embodiments of the present disclosure and not all of the embodiments.

It should be noted that the audio signals involved in the present application (including but not limited to audio signals collected by the terminal, audio signals pre-stored in the terminal or server, etc.) are information and data authorized by a user or fully authorized by all parties, and the collection, use and processing of relevant data need to comply with relevant laws, regulations and standards of relevant countries and regions, and corresponding operation portals are provided for the user to choose authorization or rejection.

Usually, speech enhancement technologies include denoising, loudness enhancement, echo cancellation and reverberation removal, etc. However, after using the current speech enhancement technologies to enhance an audio signal, good noise reduction results cannot be obtained. In order to solve the problem, the embodiments of the present disclosure provide an audio signal processing method, which will be introduced in the following with specific embodiments.

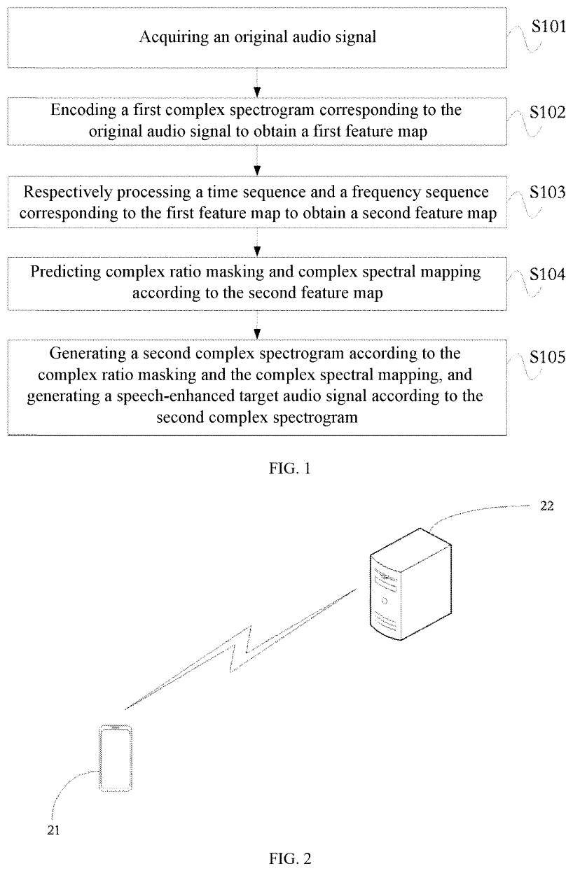

FIG. 1 is a flowchart of an audio signal processing method provided by an embodiment of the present disclosure. The method can be executed by an audio signal processing apparatus, which can be realized by software and/or hardware, and can be configured in an electronic device, such as a server or a terminal, where the terminal specifically includes a mobile phone, a computer or a tablet computer. In addition, the audio signal processing method described in this embodiment can be applied to application scenarios including front-end voice processing of audio and video conference, noise processing of long-distance pickup sound, voice recognition of conference scene, etc. For example, in the audio and video conference, a microphone is located in the middle of a conference room. Because a speaker may be far away from the microphone, the speaker's voice in the audio signal collected by the microphone is small and noisy. In this case, the method described in this embodiment can be used to denoise the audio signal, so as to realize voice enhancement. For another example, in the long-distance pickup sound scene, a recorder of an audio and video may be outdoors, and a recorded person is far away from a recording device (such as a video camera), resulting in great noise in the audio signal recorded by the recording device. The method described in this embodiment can be used to denoise the audio signal. For another example, in the conference scene, after denoising the audio signal, speech recognition can be further performed on the denoised audio signal, thus improving the accuracy of speech recognition. In addition, the method described in this embodiment can be executed by a terminal 21 or a server 22 as shown in FIG. 2. If it is executed by the terminal 21, the terminal 21 can adopt this method to process an original audio signal captured by the terminal 21. If it is executed by the server 22, the terminal 21 can send the original audio signal captured by the terminal 21 to the server 22, and the server 22 adopts this method to process the original audio signal. In some embodiments, the server 22 can not only process the original audio signal captured by the terminal 21, but also process the original audio signal pre-stored in the server 22 and the original audio signal from other terminals or other servers. That is to say, when the method is executed by the server 22, the source of the original audio signal to be processed is not limited. This embodiment aims to extract a target audio signal, that is useful components in the original audio signal, such as the user's voice, from the original audio signal damaged by noise, so as to realize monophonic speech enhancement. This method can be widely used in speech communication to obtain better perceptual quality and intelligibility, and it can also be used in an automatic speech recognition (ASR) system with more robust speech recognition performance. As shown in FIG. 1, the specific steps of this method are as follows.

S101, acquiring an original audio signal.

For example, the server 22 can receive the original audio signal from the terminal 21, other terminals or other servers. Alternatively, the server 22 can receive audio and video information, such as a real-time audio and video stream, from the terminal 21, other terminals or other servers, and further, the server 22 can extract the original audio signal from the audio and video information, for example, extract an audio stream from a real-time audio and video stream.

S102, encoding a first complex spectrogram corresponding to the original audio signal to obtain a first feature map.

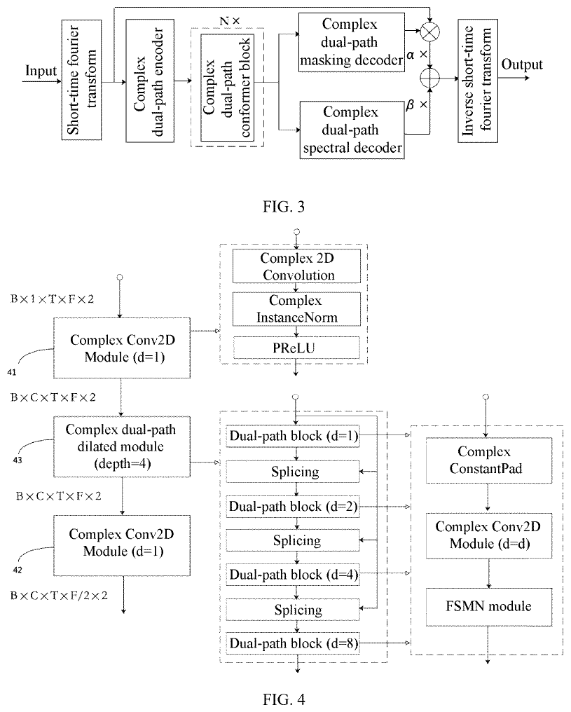

For example, the original audio signal is a noisy speech signal, and a waveform y of the speech signal can be expressed as y=s+n, where s represents a useful signal, such as a noiseless speech signal, n represents noise. In this embodiment, a completely complex dual-path dual-decoder conformer network (D2Former) can be deployed in the server 22. The architecture diagram of the D2Former is shown in FIG. 3. Specifically, the D2Former includes a complex dual-path encoder, a complex dual-path conformer block repeated for N times and two independent complex dual-path decoders. The two independent complex dual-path decoders are a complex dual-path masking decoder and a complex dual-path spectral decoder respectively, where the complex dual-path masking decoder is configured to learn complex ratio masking, and the complex dual-path spectral decoder is configured to learn complex spectral mapping. Specifically, the original audio signal can be used as an input of the D2Former, and the input waveform y is first converted into a complex spectrogram. For example, the input waveform y is transformed by short-time fourier transform (STFT) to obtain the complex spectrogram, which is marked as a first complex spectrogram, and the complex spectrogram is expressed as Y=STFT(y)∈C^{T×F}, where C represents a complex domain, T represents a time dimension of Y, and F represents a frequency dimension of Y. For example, Y includes T time sequences and F frequency sequences, and the time sequences and the frequency sequences are complex sequences respectively. Further, the first complex spectrogram is encoded to obtain the first feature map.

As shown in FIG. 3, the first complex spectrogram Y is input into the complex dual-path encoder to extract an advanced complex feature sequence, and the advanced complex feature sequence can be recorded as the first feature map.

S103, respectively processing a time sequence and a frequency sequence corresponding to the first feature map to obtain a second feature map.

For example, the first feature map is input into the complex dual-path conformer block repeated for N times for processing, so that the complex dual-path conformer block processes the time sequence and the frequency sequence corresponding to the first feature map respectively to obtain the second feature map. Specifically, the complex dual-path conformer block includes a time path and a frequency path. In the complex dual-path conformer block, sub-band information in the time path and full-band information in the frequency path are alternately modeled, thereby obtaining the second feature map.

S104, predicting complex ratio masking and complex spectral mapping according to the second feature map.

Specifically, the second feature map can be used as an input of the complex dual-path masking decoder and an input of the complex dual-path spectral decoder as shown in FIG. 3. Specifically, the complex dual-path masking decoder can predict the complex ratio masking according to the second feature map, and the complex dual-path spectral decoder can predict the complex spectral mapping according to the second feature map.

In an implementation, the predicting the complex ratio masking and the complex spectral mapping according to the second feature map includes: taking the second feature map as an input of a masking decoder, and outputting the complex ratio masking through the masking decoder; and taking the second feature map as an input of a spectral decoder, and outputting the complex spectral mapping through the spectral decoder.

For example, the second feature map is used as the input of the complex dual-path masking decoder, so that the complex dual-path masking decoder outputs the complex ratio masking. The second feature map is used as the input of the complex dual-path spectral decoder, so that the complex dual-path spectral decoder outputs the complex spectral mapping.

S105, generating a second complex spectrogram according to the complex ratio masking and the complex spectral mapping, and generating a speech-enhanced target audio signal according to the second complex spectrogram.

For example, after the complex ratio masking and the complex spectral mapping are decoded respectively, the complex ratio masking and the complex spectral mapping are weighted and summed to generate the second complex spectrogram. After an inverse short-time fourier transform (ISTFT) is performed on the second complex spectrogram, an obtained audio signal is the speech-enhanced target audio signal. The speech-enhanced target audio signal can be used as an output of the D2Former. The speech-enhanced target audio signal can also be called a noise-reduced target audio signal.

In an implementation, the generating the second complex spectrogram according to the complex ratio masking and the complex spectral mapping includes: generating an enhanced spectrogram according to the first complex spectrogram and the complex ratio masking; and generating the second complex spectrogram according to the enhanced spectrogram and the complex spectral mapping.

For example, the complex ratio masking is denoted as M, and M=M_{R}+jM_{I}, where M_{R} denotes a real part of M, and M_{I} denotes an imaginary part of M. Further, the complex ratio masking is applied to the first complex spectrogram Y to generate the enhanced spectrogram S′, and

$${S}^{′} = {S}_{R}^{′} + {jS}_{I}^{′} = M ⊙ Y ,$$

where ⊙ denotes element-by-element complex multiplication,

$${S}_{R}^{′}$$

denotes a real part of S′, and S′_{I} denotes an imaginary part of S′. Further, the complex spectral map is denoted as S″, and

$${S}^{″} = {S}_{R}^{″} + {jS}_{I}^{″} ,$$

where

$${S}_{R}^{″}$$

denotes a real part of S″, and

$${S}_{I}^{″}$$

denotes an imaginary part of S″. Further, S′ and S″ are weighted and summed to generate the second complex spectrogram, where the second complex spectrogram is denoted as S, and S can be expressed as the following equation (1):

$$S = {α S}^{′} + {β S}^{″} = ( {α S}_{R}^{′} + {β S}_{R}^{″} ) + j ( {α S}_{I}^{′} + {β S}_{I}^{″} ) \qquad ( 1 )$$

where α and β denote weighting factors respectively.

A waveform of the speech-enhanced target audio signal obtained after the inverse short-time fourier transform (ISTFT) is performed on the second complex spectrogram S can be denoted as ŝ. Therefore, the D2Former shown in FIG. 3 can process a noisy speech waveform y=s+n into an enhanced speech waveform ŝ.

The embodiments of the present disclosure, by a encoding a first complex spectrogram corresponding to an original audio signal to obtain a first feature map, and respectively processing a time sequence and a frequency sequence corresponding to the first feature map to obtain a second feature map, and learning complex ratio masking and complex spectral mapping at the same time according to the second feature map, both the amplitude spectrum and phase of the original audio signal are enhanced by means of combining masking prediction and spectral prediction, thereby improving the speech enhancement effect. Speech enhancement can greatly improve the quality of speech, solve the problem of noise interference and improve the effect of speech recognition.

The complex dual-path encoder, complex dual-path conformer block, complex dual-path masking decoder and complex dual-path spectral decoder shown in FIG. 3 are described in detail below.

In an implementation, the encoding the first complex spectrogram corresponding to the original audio signal includes: encoding the first complex spectrogram corresponding to the original audio signal by using a complex dual-path encoder, where the complex dual-path encoder includes a first convolution module, a second convolution module and a first dual-path dilated module.

As shown in FIG. 4, the complex dual-path encoder includes two complex two-dimensional convolution modules (Complex Conv2D Module) and a complex dual-path dilated module. The Complex Conv2D Module 41 is denoted as the first convolution module, the Complex Conv2D Module 42 is denoted as the second convolution module, and the complex dual-path dilated module 43 are denoted as the first dual-path dilated module. Specifically, the complex dual-path encoder is adopted to encode the first complex spectrogram Y.

Specifically, the internal structure of the Complex Conv2D Module 41 is the same as that of the Complex Conv2D Module 42. Taking the Complex Conv2D Module 41 as an example, the Complex Conv2D Module 41 includes a complex two-dimensional convolution (Complex 2D Convolution), a complex instance normalization (Complex InstanceNorm), and a complex activation function (for example, Parametric Rectified Linear Unit (PRELU)), where the Complex 2D Convolution is a complex layer with trainable parameters. It is assumed that the complex layer with trainable parameters is denoted as H, and an input of the complex layer is a complex sequence, and the complex sequence is denoted as Z=Z_{R}+jZ_{I}, where Z_{R} denotes a real part of Z, and Z_{I} denotes an imaginary part of Z. Specifically, Z may be Y as described above, or Z may be a result of Y being processed by a module. An output of the complex layer H with trainable parameters is denoted as H(Z), and H(Z) can be expressed as the following equation (2):

H(Z)=[H_{R}(Z_{R})−H_{I}(Z_{I})]+j[H_{R}(Z_{I})+H_{I}(Z_{R})] (2)
where H_{R} is a real number layer in the complex number layer H with trainable parameters, and H_{I} is an imaginary number layer in the complex number layer H with trainable parameters. The real number layer and the imaginary number layer can each perform an operation or a computation on the real number values, so as to form the complex numbers shown in the equation (2) from a result of the operation or the computation.

In addition, the Complex InstanceNorm is a complex layer without trainable parameters, and a complex computation that can be realized by the Complex InstanceNorm is normalization, regularization or standardization. It is assumed that a function that realizes the normalization, regularization or standardization is denoted as N, then the Complex InstanceNorm can be used to normalize, regularize or standardize the real part and the imaginary part of the above-mentioned H(Z) respectively. For example, an output of the Complex InstanceNorm is denoted as N(H(Z)), and N(H(Z)) can be expressed as the following equation (3):

N(H(Z))=N(H(Z)_{R})+jN(H(Z)_{I}) (3)
where H(Z)_{R} denotes [H_{R}(Z_{R})−H_{I}(Z_{I})], and H(Z)_{I} denotes [H_{R}(Z_{I})+H_{I}(Z_{R})].

In an implementation, the first convolution module is configured to expand the first complex spectrogram from one feature channel to a plurality of feature channels; the second convolution module is configured to reduce a frequency dimension corresponding to the first complex spectrogram; the first dual-path dilated module is configured to respectively extract features of the first complex spectrogram in a time dimension and the frequency dimension corresponding to the first complex spectrogram.

In some embodiments, the first complex spectrogram Y can be denoted as an initial feature map, and a size of the feature map can be denoted as B×1×T×F×2 as shown in FIG. 4, where B represents B parallel audio signals, 1 represents the number of feature channels, and 2 represents a real part and an imaginary part of a complex sequence. The Complex Conv2D Module 41 can expand the first complex spectrogram Y from one feature channel to C feature channels. The Complex Conv2D Module 42 can halve the frequency dimension from F to F/2 to obtain reasonable complexity. The complex dual-path dilated module 43 is used to respectively extract features of the first complex spectrogram Y in the time dimension and the frequency dimension.

In an implementation, the first dual-path dilated module includes a plurality of dual-path blocks connected in sequence, and a dilated factor of a latter dual-path block is twice that of a previous dual-path block in the connection direction.

As shown in FIG. 4, the complex dual-path dilated module 43 has four levels of depth. Specifically, the complex dual-path dilated module 43 includes four dual-path blocks (DPBlocks), where each DPBlock includes a complex constant pad (Complex ConstantPad), a Complex Conv2D Module (Complex Conv2D Module) and a complex feedforward sequential memory network (CFSMN) module. Because the Complex Conv2D Module in each DPBlock will reduce the time dimension, it is necessary to for the Complex ConstantPad to increase the time dimension in advance by supplementing 0, so that the time dimension output by the Complex Conv2D Module can be maintained at a T value. In addition, the Complex Conv2D Module in each DPBlock is responsible for feature extraction of the first complex spectrogram in the time dimension.

Specifically, as shown in FIG. 4, four dual-path blocks can be connected in sequence, where dilated factors d of the four dual-path blocks is 1, 2, 4 and 8 respectively, that is, the dilated factor of the latter dual-path block is twice that of the previous dual-path block. In addition, the dilated factor d of the Complex Conv2D Module in each dual-path block is consistent with that of the dual-path block. For example, if the dilated factor d of the first dual-path block is 1, the dilated factor d of the Complex Conv2D Module in the first dual-path block is also 1, and so on, and if the dilated factor d of the fourth dual-path block is 8, the dilated factor d of the Complex Conv2D Module in the fourth dual-path block is also 8. In addition, in some other embodiments, the Complex Conv2D Module in each dual-path block can also be denoted as a dilated convolution, where the Complex Conv2D Module with d greater than 1 is denoted as an extended convolution. When d is greater than 1, a receptive field of the Complex Conv2D Module can be increased. For example, when d=1, the Complex Conv2D Module can extract features from 10 time sequences, when d=2, the Complex Conv2D Module can extract features from 20 time sequences, and so on. In addition, it can be understood that an internal structure of the Complex Conv2D Module in each dual-path block is similar to an internal structure of the Complex Conv2D Module 41 or the Complex Conv2D Module 42, which will not be repeated here. The CFSMN module includes a CFSMN layer to learn remote frequency correlation. Specifically, the CFSMN module in each DPBlock is responsible for feature extraction of the first complex spectrogram in the frequency dimension.

In an implementation, an input of any dual-path block other than the first dual-path block is a splicing result of an input of the first dual-path block and an output of a previous dual-path block of the any dual-path block.

As shown in FIG. 4, among the four dual-path blocks, the output of the first three dual-path blocks and their input are connected by short circuit. Specifically, starting from the second dual-path block, the input of any dual-path block is a splicing result of the output of the previous dual-path block of the any dual-path block and the input of the first dual-path block. For example, a spliced result obtained by splicing an output of a first dual-path block and an input of the first dual-path block is an input of the second dual-path block. A spliced result obtained by splicing an output of the second dual-path block and the input of the first dual-path block is an input of the third dual-path block. A spliced result obtained by splicing an output of the third dual-path block and the input of the first dual-path block is an input of the fourth dual-path block. In addition, it can be understood that since the splicing process will increase the number of feature channels, the number of feature channels in input information of any dual-path block will be greater than C starting from the second dual-path block, resulting in the number of feature channels in the input information of the Complex Conv2D Module in any dual-path block being greater than C. However, by configuring the Complex Conv2D Module, the number of the feature channels in the information output by the Complex Conv2D Module can be restored to the value of C, so that the number of feature channels in the input information of the complex dual-path dilated module 43 and the number of feature channels in its output information are remained the value of C respectively. As shown in FIG. 4, a size of the output information of the complex dual-path dilated module 43 is B×C×T×F×2, and a feature map generated by the output information of the complex dual-path dilated module 43 after being processed by the Complex Conv2D Module 42 is a three-dimensional time-frequency map with a size of B×C×T×F/2×2, where the three-dimensional time-frequency map is the first feature map obtained by encoding the first complex spectrogram by the complex dual-path encoder.

In this embodiment, the dual-path design of the complex dual-path encoder not only improves the feature representation in the frequency dimension, but also increases the receptive field of the Complex Conv2D Module through dilated convolution.

Considering that the feature map generated by the complex dual-path encoder is a three-dimensional time-frequency map with a size of B×C×T×F/2×2, this embodiment applies a dual-path self attention mechanism on the three-dimensional time-frequency map to independently and alternately process the time sequence and the frequency sequence respectively.

In an implementation, the respectively processing the time sequence and the frequency sequence corresponding to the first feature map includes: reshaping the first feature map into a time sequence; processing the time sequence through a time converter by adopting a self attention mechanism to obtain an output of the time converter; obtaining a frequency sequence according to the output of the time converter; and processing the frequency sequence through a frequency converter by adopting the self attention mechanism to obtain an output of the frequency converter.

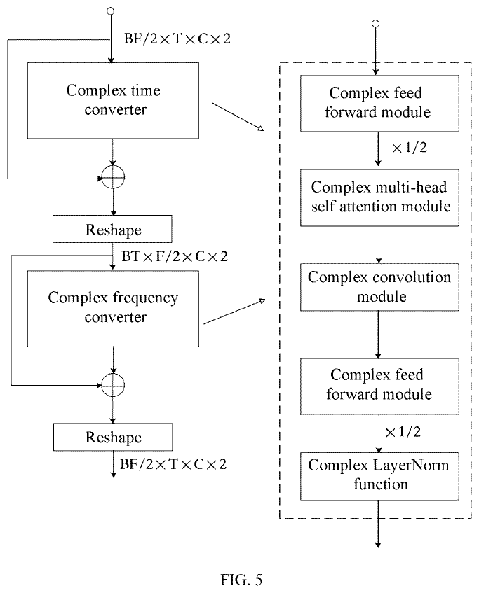

As shown in FIG. 5, the complex dual-path conformer block includes a complex time conformer and a complex frequency conformer. Both the complex time conformer and the complex frequency conformer are based on an original converter and extend to a complex domain.

For example, the three-dimensional time-frequency diagram with a size of B×C×T×F/2×2 output by the complex dual-path encoder is reshaped to a time sequence a size of which is BF/2×T×C×2 as shown in FIG. 5. The time sequence can be used as an input of the complex time converter, and the complex time converter can perform self attention mechanism computation along the time sequence. In some embodiments, an output of the complex time converter can be reshaped to a frequency sequence, a size of which is BT×F/2×C×2 as shown in FIG. 5. Further, the frequency sequence can be used as an input of the complex frequency converter, and the complex frequency converter can perform self attention mechanism computation along the frequency sequence. In some other embodiments, the time sequence with the size of BF/2×T×C×2 can be reshaped to a frequency sequence with the size of BT×F/2×C×2.

In an implementation, the obtaining the frequency sequence according to the output of the time converter includes: connecting the output of the time converter with the input of the time converter to obtain a first connection result; and reshaping the first connection result to obtain the frequency sequence; correspondingly, after the processing the frequency sequence through the frequency converter by adopting the self attention mechanism to obtain the output of the frequency converter, the method further includes: connecting the output of the frequency converter with an input of the frequency converter to obtain a second connection result; and reshaping the second connection result to obtain an updated time sequence.

For example, in some other embodiments, the input of the complex time converter and the output of the complex time converter as shown in FIG. 5 can be connected to obtain a first connection result, and then the first connection result can be reshaped to obtain a frequency sequence with a size of BT×F/2×C×2. After the frequency sequence is processed by the complex frequency converter, the input of the complex frequency converter and an output of the complex frequency converter can be connected to obtain a second connection result, and then the second connection result is reshaped to obtain an updated time sequence with a size of BF/2×T×C×2. The updated time sequence can be used as a new input of the complex time converter, so that the complex time converter can process the updated time sequence to obtain a new output of the complex time converter. Further, the new input of the complex time converter and the new output of the complex time converter are connected to obtain a new first connection result, and the new first connection result is reshaped to obtain a new frequency sequence. The new frequency sequence can be used as a new input of the complex frequency converter, and the new frequency sequence is processed to obtain a new output of the complex frequency converter, the new input of the complex frequency converter is further connected with the new output of the complex frequency converter to obtain a new second connection result, and the new second connection result is reshaped to obtain a new time sequence. The new time sequence is input into the complex time converter again, and the subsequent processing is continued according to the flow shown in FIG. 5, and so on, which repeats for N times, so that the time sequence and the frequency sequence are processed for N times respectively. In each processing process, the time sequence and the frequency sequence are alternately processed, and the time sequence and the frequency sequence in each processing process will be updated.

As shown in FIG. 5, an internal structure of the complex time converter is the same as that of the complex frequency converter. For example, taking the complex time converter as an example, the complex time converter includes a complex feed forward module, a complex multi-head self attention module, a complex convolution modul, and a complex LayerNorm function, where a complex computation in the complex feed forward module and a complex computation in the complex convolution module can be referred to the above equation (2). The complex multi-head self attention module in the complex time converter can be denoted as a time sequence attention, and the complex multi-head self attention module in the complex frequency converter can be denoted as a frequency sequence attention. The time sequence attention and the frequency sequence attention adopt the same mechanism. For example, taking the time sequence attention as an example, an input of the time sequence attention is a complex sequence, which is denoted as Z=Z_{R}+jZ_{I}, where Z_{R} is a real part of Z, and Z_{I} is an imaginary part of Z. Complex parameters in the complex multi-head self attention module include W^{Q}, W^{K} and W^{V}, where

$${W}^{Q} = {W}_{R}^{Q} + {jW}_{I}^{Q} , {W}^{K} = {W}_{R}^{K} + {jW}_{I}^{K} ,$$

$${W}^{V} = {W}_{R}^{V} + {jW}_{I}^{V} , {W}_{R}^{Q}$$

is a real part of W^{Q}, and

$${W}_{I}^{Q}$$

is an imaginary part of W^{Q}.

$${W}_{R}^{K}$$

is a real part of W^{K}, and

$${W}_{I}^{K}$$

is an imaginary part of W^{K}.

$${W}_{R}^{V}$$

is a real part of W^{V}, and

$${W}_{I}^{V}$$

is an imaginary part or W^{V}. Queries in the complex multi-head self attention module are denoted as Q, keys are denoted as K, and values are denoted as V, where Q, K, and V are obtained by computing according to the following equation (4):

Q=ZW^{Q},K=ZW^{K},V=ZW^{V} (4)

Further, a complex self attention ComplexAttention(Q,K,V) can be obtained by computing according to the following equation (5):

$$ComplexAttention ( Q , K , V ) = softmax ( \frac{\vert {QK}^{T} \vert}{\sqrt{{d}_{k}}} ) V \qquad ( 5 )$$

where |⋅| denotes an absolute value, dₖ denotes a dimension of the feature channel, and a complex matrix product QK^{T} can be obtained by computing according to the following equation (6):

$${QK}^{T} = ( {Q}_{R} {K}_{R}^{T} - {Q}_{I} {K}_{I}^{T} ) + j ( {Q}_{R} {K}_{I}^{T} + {Q}_{I} {K}_{R}^{T} ) \qquad ( 6 )$$

where Q_{R} is a real part of Q, and Q_{I} is an imaginary part of Q. K_{R} is a real part of K, and K_{I} is an imaginary part of K. K^{T} is a transpose of K.

In this embodiment, the multi-head attention adopted by the complex multi-head self attention module can specifically be four attention heads. In addition, by connecting the input of the complex time converter and the output of the complex time converter, and connecting the input of the complex frequency converter and the output of the complex frequency converter, it is convenient to carry out model training on the D2Former.

As shown in FIG. 3, the embodiments of the present disclosure provides a dual-decoder scheme. That is, using the complex ratio masking and the complex spectral mapping to simultaneously estimate amplitude and phase spectrum, i.e., the spectrum of the denoised target audio signal. Because two decoders output more information, more and more universal feature representation can be learned through the dual-decoder scheme. In addition, information output by one decoder may be lost, but information output by two decoders can compensate each other, so that any lost information can be compensated, thereby improving the upper limit of performance.

In an implementation, the masking decoder includes a second dual-path dilated module, a complex transpose layer, a first complex convolution layer and a second complex convolution layer; the complex transpose layer is configured to reset a frequency dimension; the first complex convolution layer is configured to compress the second feature map from a plurality of feature channels into one feature channel; the second complex convolution layer is configured to project an output of a previous layer thereof to a masking domain.

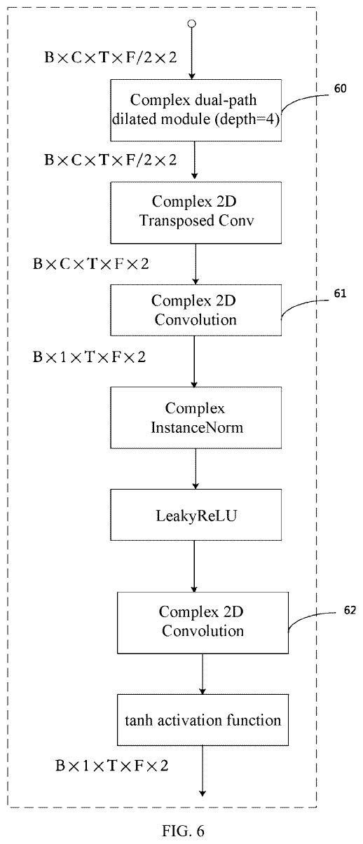

As shown in FIG. 6, the complex dual-path masking decoder includes a complex dual-path dilated module 60 with a depth of 4, a complex transpose layer (Complex 2D Transposed Conv), a Complex 2D Convolution 61, a Complex InstanceNorm, a complex activation function (for example, Leaky Rectified Linear Unit (LeakyReLU)), a Complex 2D Convolution 62, and a tanh activation function, where the complex dual-path dilated module 60 is denoted as the second dual-path dilated module, and an internal structure of the complex dual-path dilated module 60 is the same as that of the complex dual-path dilated module as described above, and the details will not be repeated here. The Complex 2D Convolution 61 is referred to as the first complex convolution layer, and the Complex 2D Convolution 62 is referred to as the second complex convolution layer. The complex dual-path dilated module 60 is configured to aggregate information from the time dimension and the frequency dimension. For example, an output of the complex dual-path conformer block repeated for N times is reshaped to obtain the second feature map, and a size of the second feature map is B×C×T×F/2×2. The second feature map can be used as an input of the complex dual-path masking decoder and an input of the complex dual-path spectral decoder, respectively. The complex dual-path dilated module 60 in the complex dual-path masking decoder can respectively extract features of the second feature map in the time dimension and the frequency dimension. The dimension of the output of the complex dual-path dilated module 60 is consistent with the dimension of its input. The Complex 2D Transposed Conv is configured to reset the frequency dimension, for example, to reset the frequency dimension from F/2 to F. The Complex 2D Convolution 61 is configured to compress the second feature map from C feature channels to one feature channel. For the output of the Complex 2D Convolution 61, a computation of the Complex InstanceNorm and the complex activation function LeakyReLU is performed. The Complex 2D Convolution 62 can project an output of the complex activation function Leaky ReLU to the masking domain, and then use the tanh activation function to limit an estimated range of cIRM.

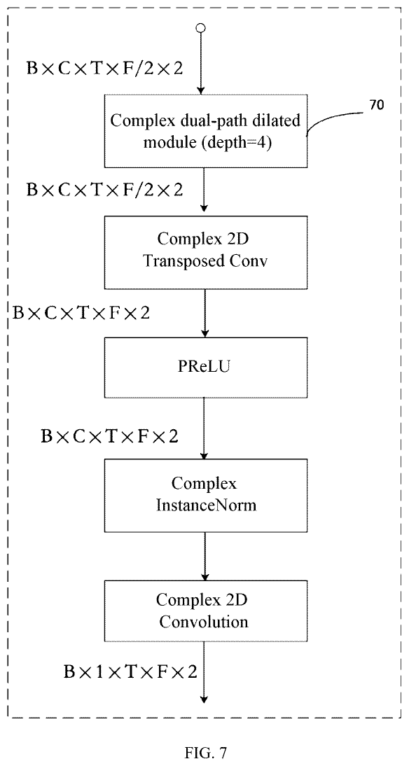

As shown in FIG. 7, the complex dual-path spectral decoder includes a complex dual-path dilated module 70, a Complex 2D Transposed Conv, a complex activation function (for example, Parametric Rectified Linear Unit (PReLU)), a Complex InstanceNorm, and a Complex 2D Convolution, where the Complex 2D Transposed Conv is configured to reset the frequency dimension, for example, reset the frequency dimension from F/2 to F. The Complex 2D Convolution is configured to compress the second feature map from C feature channels to one feature channel.

In this embodiment, a completely complex D2Former network model is used for monophonic speech enhancement. Different from the existing models, the D2Former network model can learn both the complex ratio masking and the complex spectral mapping at the same time, that is, it combines the advantages of two training targets of the complex ratio masking and the complex spectral mapping through a joint learning framework, thus improving the respective performance upper limits of the complex ratio masking and the complex spectral mapping. In addition, the speech quality after speech enhancement can be improved by combining the complex ratio masking and the complex spectral mapping with the completely complex D2Former network model for monophonic speech enhancement. In the D2Former network model, the D2Former network model can be extended to the complex domain, and is designed as a dual-path complex time-frequency self attention architecture (such as a complex dual-path conformer block including a time converter and a frequency converter), so as to effectively model the complex time sequence and the complex frequency sequence. In addition, frequency recursion is performed based on a time-dependent complex extended convolution and complex feedforward sequence memory network (CFSMN), and a dual-path learning structure is used to further improve the time-frequency feature representation in the encoder and the decoder. Therefore, the D2Former network model can make full use of complex computation, dual-path processing and joint training target. Compared with the existing models, the D2Former network model has achieved better noise reduction results in the VoiceBank+Demand benchmark test, and the number of parameters of the D2Former network model is less, such as 0.87M.

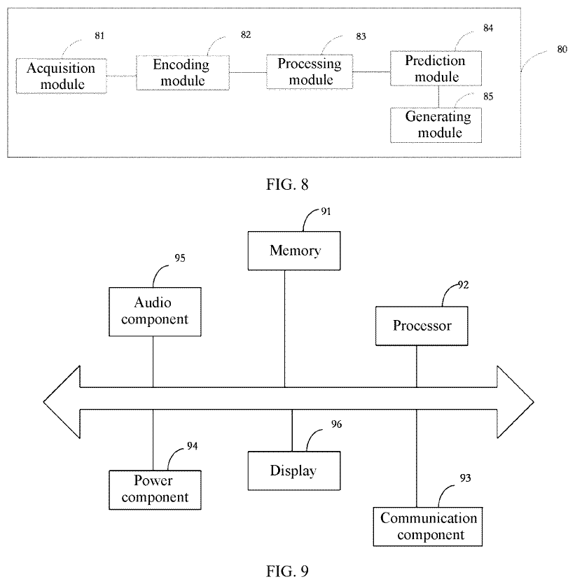

FIG. 8 is a schematic structural diagram of an audio signal processing apparatus provided by an embodiment of the present disclosure. The audio signal processing apparatus provided by the embodiment of the present disclosure can execute the processing flow provided by the embodiment of the audio signal processing method. As shown in FIG. 8, the audio signal processing apparatus 80 includes:
an acquisition module 81, configured to acquire an original audio signal; an encoding module 82, configured to encode a first complex spectrogram corresponding to the original audio signal to obtain a first feature map; a processing module 83, configured to respectively process a time sequence and a frequency sequence corresponding to the first feature map to obtain a second feature map; a prediction module 84, configured to predict complex ratio masking and complex spectral mapping according to the second feature map; and a generating module 85, configured to generate a second complex spectrogram according to the complex ratio masking and the complex spectral mapping, and generate a speech-enhanced target audio signal according to the second complex spectrogram.

In an implementation, the encoding module 82, when encoding the first complex spectrogram corresponding to the original audio signal, is specifically configured to: encode the first complex spectrogram corresponding to the original audio signal by using a complex dual-path encoder, where the complex dual-path encoder includes a first convolution module, a second convolution module and a first dual-path dilated module.

In an implementation, the first convolution module is configured to expand the first complex spectrogram from one feature channel to a plurality of feature channels; the second convolution module is configured to reduce a frequency dimension corresponding to the first complex spectrogram; the first dual-path dilated module is configured to respectively extract features of the first complex spectrogram in a time dimension and the frequency dimension corresponding to the first complex spectrogram.

In an implementation, the first dual-path dilated module includes a plurality of dual-path blocks connected in sequence, and a dilated factor of a latter dual-path block is twice that of a previous dual-path block in the connection direction.

In an implementation, an input of any dual-path block other than the first dual-path block is a splicing result of an input of the first dual-path block and an output of a previous dual-path block of the any dual-path block.

In an implementation, the processing module 83, when respectively processing the time sequence and the frequency sequence corresponding to the first feature map, is specifically configured to: reshape the first feature map into a time sequence; process the time sequence through a time converter by adopting a self attention mechanism to obtain an output of the time converter; obtain a frequency sequence according to the output of the time converter; and process the frequency sequence through a frequency converter by adopting the self attention mechanism to obtain an output of the frequency converter.

In an implementation, the processing module 83, when obtaining the frequency sequence according to the output of the time converter, is specifically configured to: connect the output of the time converter with the input of the time converter to obtain a first connection result; and reshape the first connection result to obtain the frequency sequence; correspondingly, the processing module 83, after processing the frequency sequence through the frequency converter by adopting the self attention mechanism to obtain the output of the frequency converter, is further configured to: connect the output of the frequency converter with an input of the frequency converter to obtain a second connection result; and reshape the second connection result to obtain an updated time sequence.

In an implementation, the prediction module 84, when predicting the complex ratio masking and the complex spectral mapping according to the second feature map, is specifically configured to: take the second feature map as an input of a masking decoder, and output the complex ratio masking through the masking decoder; and take the second feature map as an input of a spectral decoder, and output the complex spectral mapping through the spectral decoder.

In an implementation, the masking decoder includes a second dual-path dilated module, a complex transpose layer, a first complex convolution layer and a second complex convolution layer; the complex transpose layer is configured to reset a frequency dimension; the first complex convolution layer is configured to compress the second feature map from a plurality of feature channels into one feature channel; the second complex convolution layer is configured to project an output of a previous layer thereof to a masking domain.

In an implementation, the generating module 85, when generating the second complex spectrogram according to the complex ratio masking and the complex spectral mapping, is specifically configured to: generate an enhanced spectrogram according to the first complex spectrogram and the complex ratio masking; and generate the second complex spectrogram according to the enhanced spectrogram and the complex spectral mapping.

The audio signal processing apparatus of the embodiment shown in FIG. 8 can be used to implement the technical scheme of the above-mentioned method embodiments, and its implementation principle and technical effect are similar, which will not be repeated here.

The audio signal processing method and apparatus, the device and the storage medium provided by the embodiments of the present disclosure, by a encoding a first complex spectrogram corresponding to an original audio signal to obtain a first feature map, and respectively processing a time sequence and a frequency sequence corresponding to the first feature map to obtain a second feature map, and learning complex ratio masking and complex spectral mapping at the same time according to the second feature map, both the amplitude spectrum and phase of the original audio signal are enhanced by means of combining masking prediction and spectral prediction, thereby improving the speech enhancement effect. Speech enhancement can greatly improve the quality of speech, solve the problem of noise interference and improve the effect of speech recognition.

The internal function and structure of the audio signal processing apparatus have been described above, which can be realized as an electronic device. FIG. 9 is a structural schematic diagram of an embodiment of the electronic device provided by an embodiment of the present disclosure. As shown in FIG. 9, the electronic device includes a memory 91 and a processor 92.

The memory 91 is configured to store programs. In addition to the above programs, the memory 91 can also be configured to store various other data to support operations on the electronic device. Examples of such data include instructions for any application or method operating on the electronic device, contact data, phone book data, messages, pictures, videos, etc.

The memory 91 can be realized by any type of volatile or nonvolatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The processor 92 is coupled with the memory 91 and executes the program stored in the memory 91 for: acquiring an original audio signal; encoding a first complex spectrogram corresponding to the original audio signal to obtain a first feature map; respectively processing a time sequence and a frequency sequence corresponding to the first feature map to obtain a second feature map; predicting complex ratio masking and complex spectral mapping according to the second feature map; and generating a second complex spectrogram according to the complex ratio masking and the complex spectral mapping, and generating a speech-enhanced target audio signal according to the second complex spectrogram.

Further, as shown in FIG. 9, the electronic device may also include a communication component 93, a power component 94, an audio component 95, a display 96 and other components. Only some components are shown schematically in FIG. 9, which does not mean that the electronic device only includes the components shown in FIG. 9.

The communication component 93 is configured to facilitate wired or wireless communication between the electronic device and other devices. The electronic device can access wireless networks based on communication standards, such as wireless fidelity (WiFi), second generation (2G) or third generation (3G), or their combination. In an exemplary embodiment, the communication component 93 receives a broadcast signal or broadcast related information from an external broadcast management system via a broadcast channel. In an exemplary embodiment, the communication component 93 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

The power component 94 provides power for various components of the electronic device. The power component 94 may include a power management system, one or more power supplies and other components associated with generating, managing and distributing power for the electronic device.

The audio component 95 is configured to output and/or input audio signals. For example, the audio component 95 includes a microphone (MIC), which is configured to receive an external audio signal when the electronic device is in an operation mode, such as a call mode, a recording mode and a voice recognition mode. The received audio signal may be further stored in the memory 91 or transmitted via the communication component 93. In some embodiments, the audio component 95 further includes a speaker for outputting an audio signal.

The display 96 includes a screen, which may include a liquid crystal display (LCD) and a touch panel (TP). If the screen includes a touch panel, the screen may be implemented as a touch screen to receive an input signal from a user. The touch panel includes one or more touch sensors to sense touch, sliding and gestures on the touch panel. The touch sensor may not only sense the boundary of a touch or sliding action, but also detect the duration and pressure related to the touch or sliding operation.

In addition, the embodiments of the present disclosure also provide a computer-readable storage medium on which a computer program is stored, where the computer program is executed by a processor to implement the audio signal processing method described in the above embodiments.

It should be noted that in the present description, relational terms such as “first” and “second” are only used to distinguish one entity or operation from another entity or operation, and do not necessarily require or imply that there is any such actual relationship or order between these entities or operations. Moreover, the terms “including”, “having” or any variations thereof are intended to cover non-exclusive inclusion, so that processes, methods, products or devices containing a series of elements includes not only those elements, but also other elements not explicitly listed or elements inherent to such processes, methods, products or devices. Without further restrictions, elements defined by the phrase “including one” does not exclude the existence of other identical elements in the processes, methods, products or devices including the elements.

The above are only specific implementations of the present disclosure, so that a person skilled in the art can understand or realize the present disclosure. Many kinds of modifications to these embodiments will be obvious to a person skilled in the art, and the general principle defined herein can be implemented in other embodiments without departing from the spirit or scope of the present disclosure. Therefore, the present disclosure will not be limited to the embodiments described herein, but will be subject to the broadest scope consistent with the principle and novel features disclosed herein.

1. An audio signal processing method, comprising:
acquiring an original audio signal;
encoding a first complex spectrogram corresponding to the original audio signal to obtain a first feature map;
respectively processing a time sequence and a frequency sequence corresponding to the first feature map to obtain a second feature map;
predicting complex ratio masking and complex spectral mapping according to the second feature map; and
generating a second complex spectrogram according to the complex ratio masking and the complex spectral mapping, and generating a speech-enhanced target audio signal according to the second complex spectrogram.

2. The method according to claim 1, wherein the encoding the first complex spectrogram corresponding to the original audio signal comprises:
encoding the first complex spectrogram corresponding to the original audio signal by using a complex dual-path encoder, wherein the complex dual-path encoder comprises a first convolution module, a second convolution module and a first dual-path dilated module.

3. The method according to claim 2, wherein the first convolution module is configured to expand the first complex spectrogram from one feature channel to a plurality of feature channels;
the second convolution module is configured to reduce a frequency dimension corresponding to the first complex spectrogram;
the first dual-path dilated module is configured to respectively extract features of the first complex spectrogram in a time dimension and the frequency dimension corresponding to the first complex spectrogram.

4. The method according to claim 3, wherein the first dual-path dilated module comprises a plurality of dual-path blocks connected in sequence, and a dilated factor of a latter dual-path block is twice that of a previous dual-path block in the connection direction.

5. The method according to claim 4, wherein an input of any dual-path block other than the first dual-path block is a splicing result of an input of the first dual-path block and an output of a previous dual-path block of the any dual-path block.

6. The method according to claim 1, wherein the respectively processing the time sequence and the frequency sequence corresponding to the first feature map comprises:
reshaping the first feature map into a time sequence;
processing the time sequence through a time converter by adopting a self attention mechanism to obtain an output of the time converter;
obtaining a frequency sequence according to the output of the time converter; and
processing the frequency sequence through a frequency converter by adopting the self attention mechanism to obtain an output of the frequency converter.

7. The method according to claim 6, wherein the obtaining the frequency sequence according to the output of the time converter comprises:
connecting the output of the time converter with the input of the time converter to obtain a first connection result; and
reshaping the first connection result to obtain the frequency sequence;
correspondingly, after the processing the frequency sequence through the frequency converter by adopting the self attention mechanism to obtain the output of the frequency converter, the method further comprises:
connecting the output of the frequency converter with an input of the frequency converter to obtain a second connection result; and
reshaping the second connection result to obtain an updated time sequence.

8. The method according to claim 1, wherein the predicting the complex ratio masking and the complex spectral mapping according to the second feature map comprises:
taking the second feature map as an input of a masking decoder, and outputting the complex ratio masking through the masking decoder; and
taking the second feature map as an input of a spectral decoder, and outputting the complex spectral mapping through the spectral decoder.

9. The method according to claim 8, wherein the masking decoder comprises a second dual-path dilated module, a complex transpose layer, a first complex convolution layer and a second complex convolution layer;
the complex transpose layer is configured to reset a frequency dimension;
the first complex convolution layer is configured to compress the second feature map from a plurality of feature channels into one feature channel;
the second complex convolution layer is configured to project an output of a previous layer thereof to a masking domain.

10. The method according to claim 1, wherein the generating the second complex spectrogram according to the complex ratio masking and the complex spectral mapping comprises:
generating an enhanced spectrogram according to the first complex spectrogram and the complex ratio masking; and
generating the second complex spectrogram according to the enhanced spectrogram and the complex spectral mapping.

11. (canceled)

12. An electronic device, comprising:
a memory;
a processor; and
a computer program, wherein the computer program is stored in the memory, and configured to be executed by the processor, the processor, when executing the computer program, is configured to:
acquire an original audio signal;
encode a first complex spectrogram corresponding to the original audio signal to obtain a first feature map;
respectively process a time sequence and a frequency sequence corresponding to the first feature map to obtain a second feature map;
predict complex ratio masking and complex spectral mapping according to the second feature map; and
generate a second complex spectrogram according to the complex ratio masking and the complex spectral mapping, and generate a speech-enhanced target audio signal according to the second complex spectrogram.

13. A non-transitory computer-readable storage medium on which a computer program is stored, wherein a processor, when executing the computer program, is configured to perform the following operations:
acquiring an original audio signal;
encoding a first complex spectrogram corresponding to the original audio signal to obtain a first feature map;
respectively processing a time sequence and a frequency sequence corresponding to the first feature map to obtain a second feature map;
predicting complex ratio masking and complex spectral mapping according to the second feature map; and
generating a second complex spectrogram according to the complex ratio masking and the complex spectral mapping, and generating a speech-enhanced target audio signal according to the second complex spectrogram.

14. The electronic device according to claim 12, wherein the processor is configured to:
encode the first complex spectrogram corresponding to the original audio signal by using a complex dual-path encoder, wherein the complex dual-path encoder comprises a first convolution module, a second convolution module and a first dual-path dilated module.

15. The electronic device according to claim 14, wherein the first convolution module is configured to expand the first complex spectrogram from one feature channel to a plurality of feature channels;
the second convolution module is configured to reduce a frequency dimension corresponding to the first complex spectrogram;
the first dual-path dilated module is configured to respectively extract features of the first complex spectrogram in a time dimension and the frequency dimension corresponding to the first complex spectrogram.

16. The electronic device according to claim 15, wherein the first dual-path dilated module comprises a plurality of dual-path blocks connected in sequence, and a dilated factor of a latter dual-path block is twice that of a previous dual-path block in the connection direction.

17. The electronic device according to claim 16, wherein an input of any dual-path block other than the first dual-path block is a splicing result of an input of the first dual-path block and an output of a previous dual-path block of the any dual-path block.

18. The electronic device according to claim 12, wherein the processor is configured to:
reshape the first feature map into a time sequence;
process the time sequence through a time converter by adopting a self attention mechanism to obtain an output of the time converter;
obtain a frequency sequence according to the output of the time converter; and
process the frequency sequence through a frequency converter by adopting the self attention mechanism to obtain an output of the frequency converter.

19. The electronic device according to claim 18, wherein the processor is configured to:
connect the output of the time converter with the input of the time converter to obtain a first connection result;
reshape the first connection result to obtain the frequency sequence;
connect the output of the frequency converter with an input of the frequency converter to obtain a second connection result; and
reshape the second connection result to obtain an updated time sequence.

20. The electronic device according to claim 12, wherein the processor is configured to:
take the second feature map as an input of a masking decoder, and output the complex ratio masking through the masking decoder; and
take the second feature map as an input of a spectral decoder, and output the complex spectral mapping through the spectral decoder.

21. The electronic device according to claim 20, wherein the masking decoder comprises a second dual-path dilated module, a complex transpose layer, a first complex convolution layer and a second complex convolution layer;
the complex transpose layer is configured to reset a frequency dimension;
the first complex convolution layer is configured to compress the second feature map from a plurality of feature channels into one feature channel;
the second complex convolution layer is configured to project an output of a previous layer thereof to a masking domain.
